(19) United States
(12) Patent Application Publication
(10) Pub. No.: US 2026/0262574 A1
(43) Pub. Date: Sep. 10, 2026

(54) Grain Cleaning Apparatus for a Combine Harvester

(71) Applicant: AGCO International GmbH, Neuhausen (CH)

(72) Inventor: Alastair Cameron Morrison, Randers (DK)

(21) Appl. No.: 18/881,491

(22) PCT Filed: Jun. 15, 2023
(86) PCT No.: PCT/IB2023/056214

§ 371 Date: Jan. 6, 2025

(30) Foreign Application Priority Data
Jul. 15, 2022 (GB) 2210405.3

(51) Int. Cl. A01F 12/44; A01D 41/127; A01D 75/28

(52) U.S. Cl. CPC A01F 12/442; A01D 41/1276; A01D 75/282

(57) ABSTRACT

A grain cleaning apparatus includes a separator pan for receiving material from a separating system of a combine harvester. The separator pan comprises a set of rollers arranged as a line of parallel shafts with interdigitated discs. The speed at which the shafts is controlled by means of a controller and in dependence on a quality of the separation function implemented by the separator pan. This allows to further improve cleanliness of the separated grain.

### CROSS-REFERENCE TO RELATED APPLICATION

This application claims priority to United Kingdom Application No. GB2210405.3, filed 15 Jul. 2022, which is incorporated herein by reference in its entirety.

### FIELD

Embodiments of the present disclosure relate generally to combine harvesters, and in particular to the grain cleaning system used within a combine harvester.

### BACKGROUND

A combine harvester typically includes a threshing system for detaching grains of cereal from the ears of cereal, a separating apparatus downstream of the threshing system, and a grain cleaning apparatus for receiving grain from the separating apparatus. The grain is collected in a grain tank, and from the grain tank the grain can be unloaded by a grain unloading system, for example to a trailer pulled by a tractor which runs alongside the combine harvester.

The initial threshing creates a flow of grain to a stratification pan of the separating apparatus. The separating function further downstream of the threshing system serves to separate further grain from the crop stream and this separated grain passes through a grate-like structure onto an underlying return pan. The stratification pan and return pan are driven in an oscillating manner to convey the grain and MOG accordingly.

The crop stream collected by the stratification pan and return pan typically includes a proportion of straw, chaff, tailings and other unwanted material such as weed seeds, bugs, and tree twigs. The grain cleaning apparatus removes this unwanted material thus leaving a clean sample of grain to be delivered to the tank. A grain cleaning unit for example comprises a fan unit and sieves, the main sieve being known as the chaffer. The sieves are also driven with an oscillatory movement to transport the grain towards the grain tank. In particular, there is a fore/aft motion with a vertical component.

The sieves are used to sieve out large impurities and blows out light impurities such as chaff. An alternative to an oscillating sieve has been proposed in U.S. Pat. No. 4,696,151, in which the initial separation function within the cleaning apparatus, normally implemented by the oscillating chaffer sieve, is performed by a set of rollers. The rollers are mounted on a set of parallel shafts, and each shaft has a series of discs along its length. The discs are offset between successive shafts. The set of rollers is horizontal. The discs rotate in the same direction as the flow of material over the top. The spaces between the discs and the rollers create openings through which peanuts (in the case of U.S. Pat. No. 4,696,151) pass after a tumbling action. The tumbling action removes chaff and other debris.

The rotating disc arrangement may be used in a combine harvester for harvesting grain (wheat, oats, rye, barley). However, it is difficult to control the quality of the separation function, for example to account for different grain types, or different soil conditions. For example, the efficiency of the separation depends on the thickness of the crop mat. The thicker the crop mat, the longer it takes to separate grain, and the greater the losses (i.e. loss of grain which has not been separated from the chaff).

### BRIEF SUMMARY

The invention is defined by the claims.

According to examples in accordance with the invention, there is provided a grain cleaning apparatus for a combine harvester, comprising:
a separator pan for receiving material from a separating system (30) of the combine harvester, wherein the separator pan comprises a set of rollers, each roller comprising a shaft which extends across the fore-aft direction of the combine harvester and which carries a line of discs, wherein the discs of one shaft are interdigitated with the discs of an adjacent shaft;
a driver for driving the shafts to rotate in a same direction; and
a controller for controlling the driver,
wherein the controller is configured to control the speed at which the driver rotates the shafts in dependence on a sensed quality of the separation function implemented by the separator pan.

This grain cleaning apparatus uses rotating rollers to separate the grain from the chaff and other foreign objects. The grain is collected through openings defined between the discs and the shafts. The speed of the discs is controlled so that the quality of the separation function is regulated. The quality is sensed, and hence used as a real time feedback parameter. The quality of the separating function may be assessed as one or more of the amount of loss (i.e. grain that has not been collected), the quality/cleanliness of the grain that has been collected (i.e. the amount of undesired material such as chaff with the collected grain), and the throughput of material (i.e. the volume processed per unit time). This enables the grain cleaning quality to be controlled in a simple manner. The quality being assessed may not be the result only of the function of the separator pan itself but may be the result of multiple components, one of which is the separator pan. Thus, the performance of the separator pan can be deduced from the sensed quality measure.

The controller is for example configured to control the speed in dependence on a cleanliness of the separated material which has passed through the separator pan. Thus, the quality of the separation function in this example is the sample cleanliness.

The grain cleaning apparatus in this case may comprise an optical image sensor for imaging the separated material, wherein the controller is configured to determine the cleanliness of the separated material using image analysis. For example, an optical image sensor may be located in the grain tank of the combine harvester.

The controller is for example (additionally or alternatively) configured to control the speed in dependence on an amount of material to be separated material which has failed to pass through the separator pan.

This non-separated material represents the loss encountered during harvesting. Thus, the quality of the separation function in this example is based on the amount of loss.

The grain cleaning apparatus may in this case comprise an acoustic sensor for detecting sound at an exit of the grain cleaning apparatus, wherein the controller is configured to determine the nature of the rejected material using acoustic analysis. Acoustic analysis can determine differences in sound between grain and chaff. The exit is for example where there is a flow of rejected material.

The controller is for example configured to control the speed in dependence on the rate at which material volume is processed. Thus, throughput control is used in this example to adjust the speed of the rollers. Thus, the quality of the separation function in this example is based on the rate at which material is processed.

The grain cleaning apparatus may in this case comprise an acoustic sensor for detecting sound at an exit of the grain cleaning apparatus, wherein the controller is configured to determine the rate using acoustic analysis.

In addition to separation quality control, the controller may be further configured to control the speed in dependence on an angle of incline of the combine harvester in the fore-aft direction. Thus, in addition to separation quality control, the speed may be adjusted to provide hillside compensation. When travelling downhill, the flow of material over the separator pan is against gravity, so that a speed increase may be used to compensate.

The grain cleaning apparatus may then comprise an inclination sensor for detecting the angle of incline.

The controller may be further configured to control the speed in dependence on a crop type. Thus, in addition to separation quality control, the speed may be adjusted to tailor the operation to the grain type, for example as input by a user.

The grain cleaning apparatus may further comprise:
a stratification pan for receiving material from a threshing system of the combine harvester;
a return pan for receiving material from the separating system of the combine harvester;
a lower sieve below the separator pan; and
a clean grain chute below the lower sieve.

The return pan is for receiving the harvested crop material from the separating system and separator pan is for receiving the harvested crop material from a front end of the return pan. A second chute is for example also provided for directing tailings to a tailings collection trough. The grain cleaning apparatus preferably further comprising a fan.

The invention also provides a grain processing system for a combine harvester, comprising:
a threshing system;
a separating system; and
the grain cleaning apparatus as defined above for receiving the harvested crop material from the threshing system.

The invention also provides combine harvester comprising:
a crop cutting head; and
the grain processing system defined above for receiving the cut and threshed crop material.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 shows a combine harvester which may be adapted in accordance with the invention;

FIG. 2 shows one example of threshing system and grain cleaning apparatus in more detail;

FIG. 3 shows a grain cleaning apparatus in accordance with the invention; and

FIG. 4 shows examples of how the speed control is implemented of the rollers of the grain cleaning apparatus of FIG. 3.

### DETAILED DESCRIPTION

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure relates to the grain cleaning apparatus of a combine harvester, and in particular relates to the use of a roller arrangement for separating grain within the cleaning shoe of the combine harvester. However, the general configuration of a combine harvester will first be described.

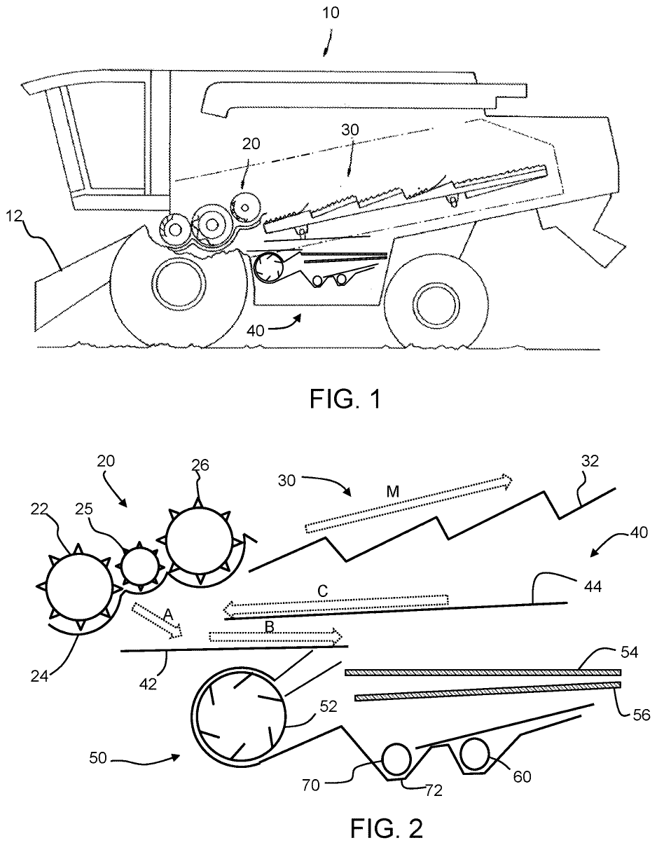

FIG. 1 shows a known combine harvester 10 to which the invention may be applied. The combine harvester includes a threshing unit 20 for detaching grains of cereal from the ears of cereal, and a separating apparatus 30 which is connected downstream of the threshing unit 20. The threshing system comprises one or more threshing units, in particular rotors, and associated concaves.

In the example shown, the separating apparatus 30 includes a plurality of parallel, longitudinally-aligned, straw walkers 32, and this is suitable for the case of a so-called straw-walker combine. The grains after separation by the separating device 30 pass to a grain cleaning apparatus 40.

The combine harvester has a front elevator housing 12 at the front of the machine for attachment of a crop cutting head (known as the header, not shown). The header when attached serves to cut and collect the crop material as it progresses across the field, the collected crop stream being conveyed up through the elevator housing 12 into the threshing unit 20.

In the example shown, the threshing system 20 is a tangential-flow ‘conventional’ threshing system, i.e. formed by rotating elements with an axis of rotation in the side-to-side direction of the combine harvester and for generating a tangential flow. For example, the ‘conventional’ threshing system includes a rotating, tangential-flow, threshing cylinder and a concave-shaped grate. The threshing cylinder includes rasp bars (not shown) which act upon the crop stream to thresh the grain or seeds from the remaining material, the majority of the threshed grain passing through the underlying grate and onto a stratification pan (also sometimes known as the grain pan).

There are also axial threshing systems, i.e. formed by rotating elements with an axis of rotation in the longitudinal direction (direction of travel). For example, the threshing section may have axially-aligned rasp bars spaced around the front section whilst the separating section has separating elements or fingers arranged in a pattern, e.g. a spiral pattern, extending from the rasp bars to the rear of the rotor.

The conventional tangential flow threshing (and separating) unit 20 and separating device 30 are shown in FIG. 2 in more detail, together with a cleaning apparatus 40.

FIG. 2 shows one particular design of the threshing unit. The threshing unit 20 includes a rotor 22 (threshing cylinder) below which is mounted a concave 24 (a concave-shaped grate). The threshing cylinder 22 includes rasp bars (not shown) which act upon the crop stream to thresh the grain or seeds from the remaining material, the majority of the threshed grain passing through the underlying concave 24 and onto the stratification pan 42 (also known as the grain pan), which for convenience is in this disclosure considered to be part of the grain cleaning apparatus 40. The stratification pan 42 is typically divided into lanes by dividers, which maintain a distribution of crop material across the width of the stratification pan.

The threshing unit 20 also comprises a beater cylinder 25 (also with a transverse rotation axis and creating a tangential flow), downstream of the threshing cylinder and a tangential-flow multi-crop separator cylinder 26 (also with a lateral rotation axis and creating a tangential flow) downstream of the beater cylinder 25.

The remainder of the crop material including straw, tailings and un-threshed grain are passed from the threshing unit 20 into the separating apparatus 30 as shown by arrow M.

In the example shown, the separating apparatus 30 includes a plurality of parallel, longitudinally-aligned, straw walkers 32, and this is suitable for the case of a so-called straw-walker combine. However, the separating apparatus 30 may instead include one or two longitudinally-aligned rotors which rotate about a longitudinal axis and convey the crop stream rearwardly in a ribbon passing along a spiral path. This is the case for a so-called axial or hybrid combine.

In all cases, the separating apparatus 30 serves to separate further grain from the crop stream, and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 and separating apparatus 30 do not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 (i.e. a grain cleaning unit 50) is provided to remove this unwanted material thus leaving a clean sample of grain to be delivered to the tank.

For clarity, the term ‘grain cleaning apparatus’ is intended to include the stratification pan 42, the return pan 44 and other parts which form the grain cleaning unit 50 (also known as a cleaning shoe).

The grain cleaning unit 50 also comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to disclosure of the invention. Furthermore, it should be appreciated that the two pans 42, 44 may take a ridged construction as is known in the art.

The grain passing through concave grate 24 falls onto the front of the stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the grate of the separator apparatus 30 falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and on top of the material conveyed from the threshing unit 20 as indicated by arrow B.

The combined crop streams thus progress rearwardly towards a rear edge of the stratification pan 42. Whilst conveyed across the stratification pan 42, the crop stream, including grain and MOG, undergoes stratification wherein the heavier grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the heavier grain to pass through the chaffer onto an underlying second sieve 56.

The chaffer 54 is coarser (with larger holes) than second sieve 56. Grain passing through chaffer 54 is incident on the lower sieve 56 which is also driven in an oscillating manner and serves to remove tailings from the stream of grain before being conveyed to on-board tank (not shown) by grain collecting auger 70 which resides in a transverse trough 72 at the bottom of the grain cleaning unit 50. Tailings blocked by sieve 56 are conveyed rearwardly by the oscillating motion thereof to a rear edge from where the tailings are directed to the returns auger 60 for reprocessing in a known manner. The grain collecting auger 70 delivers the grain to a grain tank, and a grain unloading system enables the grain to be removed from the grain tank.

The invention relates to the way grain is separated in the grain cleaning apparatus 40. In particular, the grain cleaning apparatus comprises a separator pan for receiving material from the separating system 30 of the combine harvester, thus performing the function of the chaffer sieve described above. However, instead of an oscillating sieve, the separator pan comprises a set of rollers arranged as a line of parallel shafts, with interdigitated discs. The speed at which the shafts are driven is controlled in dependence on a quality of the separation function implemented by the separator pan.

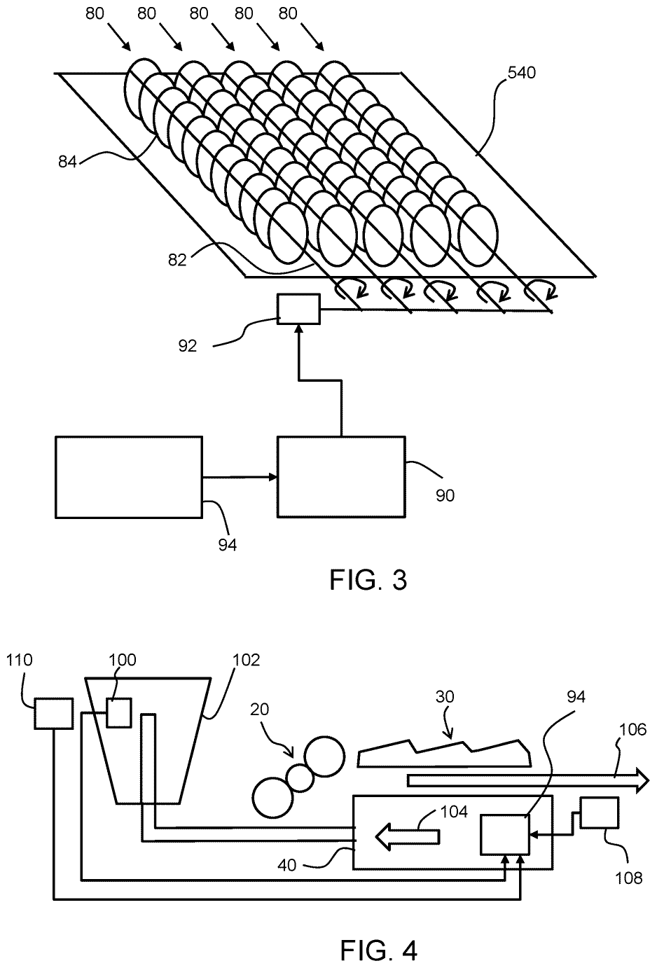

FIG. 3 shows the parts of a grain cleaning apparatus which are modified by the concept of the invention. In particular FIG. 3 shows what will be described as a separator pan 540. It replaces the chaffer sieve 54 of the conventional system of FIGS. 1 and 2. The separator pan 540 thus receiving material from the separating system 30 and from the threshing system 20. The fan is also used to blow air through the separator pan 540.

The separator pan comprises a set of rollers 80. Each roller comprises a shaft 82 which extends across the fore-aft direction of the combine harvester and which carries a line of discs 84. Five rollers 80 are shown, but there will in practice be many more. The disc shape, spacing and width will be selected according to the grain geometry. By way of example, the discs are spaced along their respective shaft by a distance in the range 5 mm to 50 mm, and the shafts are spaced by a distance in the range 50 mm to 300 mm, for example 100 mm to 200 mm. The separator pan is for example approximately 1400 mm wide and 2200 mm long. Thus, with a typical shaft spacing of 150 mm, there may be around 15 shafts (e.g. more generally in the range 10 to 20 shafts). With discs of 8 mm thickness (in the lateral direction) and a disc spacing of 20 mm, there may be around 50 discs on each shaft (more generally in the range 20 to 100).

The discs 84 of one shaft are interdigitated with the discs of an adjacent shaft. At the overlap between discs, openings are defined. The openings are limited at the sides by a pair of interdigitated discs and they are limited at the ends by the shafts. The openings are designed with a size to all the grains to be harvested to fall through the openings, but to prevent the passage of larger material such as chaff and foreign objects (stones etc.).

A driver 90 is used to drive the shafts 92 to rotate in a same direction and speed (via gearbox/clutch 92). Since each opening is defined between two discs of adjacent rollers, one side will be rotating down (the trailing side of a disc) and one side will be rotating up (the leading side of a disc). This induces a tumbling motion to the material, which assists in separating the grains from the MOG. It also prevents particles being lodged in the openings, because there are counter rotating surfaces defining the openings.

More details of the general design concept for the disc arrangement may be found in U.S. Pat. No. 4,696,151. For example, the discs are able to flex (for example being formed of spring steel) and they may have notched outer surfaces.

A controller 94 is used to control the driver 90, and in particular the speed at which the driver rotates the shafts is controlled in dependence on a quality of the separation function implemented by the separator pan 540.

This quality of separation relates to the ability of the grain cleaning apparatus to correctly extract grains rather than MOG and/or the rate at which acceptable separation can be achieved. The correct extraction can be judged based on the cleanliness of the collected grains and/or the amount of grain that has not been collected i.e. the grain loss.

FIG. 4 is used to show the different sensing options that may be used by the controller 94. FIG. 4 shows schematically the threshing system 20, the separating system 30 and the grain cleaning apparatus 40 with its controller 94.

A first option is to control the speed in dependence on a cleanliness of the separated material which has passed through the separator pan. Thus, the quality of the separation function in this example is the sample cleanliness. If the rollers are relatively slow, larger objects will be able to pass, whereas if the rollers are relatively fast, only smaller objects will be able to pass. If the grain cleanliness is too low, the speed can be increased so that more MOG is rejected. If the grain cleanliness is too high it may indicate that there is a high loss, and the speed should be decreased.

For this purpose, an optical image sensor 100 may be provided for imaging the separated material. Image analysis by the controller may be used to determine the cleanliness of the separated material. In the example shown, the optical image sensor 100 is located in the grain tank 102 of the combine harvester. However, sensing may be performed at any location where the separated grain flows or is collected—for example the flow of grain is represented by arrow 104.

A second option is to control the speed in dependence on an amount of material to be separated (i.e. grain) which has failed to pass through the separator pan, and hence which is discharged as MOG. This discharge path is represented by arrow 106. This non-separated grain represents the loss encountered during harvesting. Thus, the quality of the separation function in this example is based on the amount of loss. If the loss is too high, the speed can be decreased so that more material is separated. If the grain loss is very low it may indicate that there is significant MOG being collected, and the speed should be increased.

For this purpose, an acoustic sensor 108 may be provided for detecting sound at an exit of the grain cleaning apparatus (i.e. sensing the sound of the flow 106). The nature of the rejected material (i.e. the ratio of grain and chaff) using acoustic analysis. However, optical analysis may alternatively be used for determining the nature of the material in the flow 106.

The first and second options are complementary and can be used in combination.

A third option is to control the speed in dependence on the rate at which material volume is processed. Thus, throughput control is used in this example to adjust the speed of the rollers. Thus, the quality of the separation function in this example is based on the rate at which material is processed. The acoustic sensor 108 may be used for this purpose and again the controller may determine the rate using acoustic analysis. Alternative ways to determine the rate of separation may be to measure the rate of grain collection (rather than the flow rate of MOG) or a combination of both. A higher speed will be used for higher throughput, since the rollers carry the flow of material over the separation pan.

In addition to separation quality control, the controller may be further configured to control the speed in dependence on an angle of incline of the combine harvester in the fore-aft direction. Thus, in addition to separation quality control, the speed may be adjusted to provide hillside compensation. When travelling downhill, the flow of material over the separator pan is against gravity, so that a speed increase may be used to compensate, and a speed decrease may be used when travelling uphill. In this way, the separation function may remain constant for different inclines.

Lateral incline compensation may also be provided, for example by tilting the separation pan to maintain a horizontal lateral orientation.

FIG. 4 shows an inclination sensor for detecting the angle of incline in the fore-aft direction for uphill/downhill (rather than lateral) compensation.

The controller 94 may also control the speed in dependence on a crop type. This will be provided as an input by the user of the combine harvester. Thus, different default speeds may be provided for large grains and for small grains, and the speed compensation described above then adapts the speed relative to the default speed.

The example above shows the chaffer sieve replaced by a roller arrangement. A roller arrangement may be used for the lower sieve as well or instead, or the roller arrangement may avoid the need for the lower sieve.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

All references cited herein are incorporated herein in their entireties. If there is a conflict between definitions herein and in an incorporated reference, the definition herein shall control.

1. A grain cleaning apparatus for a combine harvester, comprising:
a separator pan for receiving material from a separating system of the combine harvester, wherein the separator pan comprises a set of rollers, each roller comprising a shaft which extends across the fore-aft direction of the combine harvester and which carries a line of discs, wherein the discs of one shaft are interdigitated with the discs of an adjacent shaft;
a driver for driving the shafts to rotate in a same direction; and
a controller for controlling the driver,
wherein the controller is configured to control the speed at which the driver rotates the shafts in dependence on a sensed quality of the separation function implemented by the separator pan.

2. The grain cleaning apparatus of claim 1, wherein the controller is configured to control the speed in dependence on a cleanliness of the separated material which has passed through the separator pan.

3. The grain cleaning apparatus of claim 2, comprising an optical image sensor for imaging the separated material, wherein the controller is configured to determine the cleanliness of the separated material using image analysis.

4. The grain cleaning apparatus of claim 1, wherein the controller is configured to control the speed in dependence on an amount of material to be separated which has failed to pass through the separator pan.

5. The grain cleaning apparatus of claim 4, comprising an acoustic sensor for detecting sound at an exit of the grain cleaning apparatus, wherein the controller is configured to determine the nature of the rejected material using acoustic analysis.

6. The grain cleaning apparatus of claim 1, wherein the controller is configured to control the speed in dependence on the rate at which material volume is processed.

7. The grain cleaning apparatus of claim 6, comprising an acoustic sensor for detecting sound at an exit of the grain cleaning apparatus, wherein the controller is configured to determine the rate using acoustic analysis.

8. The grain cleaning apparatus of claim 1, wherein the controller is further configured to control the speed in dependence on an angle of incline of the combine harvester in the fore-aft direction.

9. The grain cleaning apparatus of claim 8, comprising an inclination sensor for detecting the angle of incline.

10. The grain cleaning apparatus of claim 1, wherein the controller is further configured to control the speed in dependence on a crop type.

11. The grain cleaning apparatus of claim 1, further comprising:
a stratification pan for receiving material from a threshing system of the combine harvester;
a return pan for receiving material from the separating system of the combine harvester;
a lower sieve below the separator pan; and
a clean grain chute below the lower sieve.

12. The grain cleaning apparatus of claim 11, further comprising a fan.

13. A grain processing system for a combine harvester, comprising:
a threshing system;
a separating system; and
the grain cleaning apparatus of claim 11 for receiving the harvested crop material from the threshing system.

14. A combine harvester comprising:
a crop cutting head; and
the grain processing system of claim 13 for receiving the cut and threshed crop material.
